(19) United States
(12) Patent Application Publication
(10) Pub. No.: US 2020/0020007 A1
(43) Pub. Date: Jan. 16, 2020

(54) SYSTEM AND METHOD FOR MANAGING THE AGGREGATED PURCHASE AND FRACTIONALIZED DISPERSAL OF ENERGY PRODUCTS FOR VEHICLES

(71) Applicant: Terrence C. Ayala, Miami, FL (US)

(72) Inventor: Terrence C. Ayala, Miami, FL (US)

(21) Appl. No.: 16/503,948

(22) Filed: Jul. 5, 2019

Related U.S. Application Data
(63) Continuation-in-part of application No. 14/807,979, filed on Jul. 24, 2015, now abandoned.
Application No. 14/807,979 is a division of application No. 13/632,176, filed on Oct. 1, 2012, now abandoned.

(51) Int. Cl. G06Q 30/06

(52) U.S. Cl. CPC G06Q 30/0607

(57) ABSTRACT

A system and method through which end users can purchase automobile fuel and/or energy products on-line through a software implemented platform through which an end user generate a request which is aggregated for purchase and a filling/charging station is enabled to avail quantities of fuel and/or other energy products to satisfy the request. The system and method operates to unbundle the various components of a traditional vehicle energy product purchase transaction. One of the system's many benefits is that it allows an end user (meaning a consumer or organization consisting of many consumers) to separate the energy purchase decision from the time and place where that end user takes delivery, thereby increasing the end user's choices and flexibility. This is because the present invention allows an end user to purchase energy products and arrange for subsequent at a station of the end user's choosing.

### CROSS REFERENCE TO RELATED APPLICATIONS

This application is a continuation in part application of co-pending U.S. patent application Ser. No. 14/807,979, filed Jul. 24, 2015, which is a divisional application of U.S. patent application Ser. No. 13/632,176, filed Oct. 1, 2012, which claimed the benefit of U.S. provisional patent application Ser. No. 61/541,156, filed Sep. 30, 2011.

### BACKGROUND OF THE INVENTION

### Field of the Invention

This invention relates generally to a system and method which manages distribution of fuel and/or other energy products for vehicles.

### Description of Related Art

The existing paradigm for the purchase and delivery of energy products for vehicles, namely products that power the operation of a vehicle (be it fuel for releasing energy or energy that is stored), is well known in the art. This existing paradigm exists under the basic assumption that end users of an energy product must purchase and take delivery of the energy product simultaneously and at the same location. This existing paradigm has been referred to as “pay at the pump.” At the time this paradigm was organized, it is possible that the prevailing technology provided no reasonable alternative to a requirement that all end users must “pay at the pump.”

In the example of fuel provided in the form of gasoline, a complex system developed to facilitate the provision of the fuel for consumption through a plurality of dispensing stations (also referred to herein as “filling stations,” “charging stations” or “gas stations”) accessible by end users. Such is reflected when the traditional retail price of gasoline at a gas station is analyzed in its parts. When an end user completes a traditional gas purchase at a gas station, the end user is actually paying for the following: (1) a commodity price for gas, reflecting the cost of extraction and refinement, (2) a fee for transporting the gas from the refinery to a local terminal, (3) a fee for distributing the gas from the local terminal to a dispensing service station, (4) a fee to cover the dispensing station's operating costs, (5) a fee to cover the branding and marketing of the gas, and (6) taxes and inspection fees collected by local, state and federal governments. In addition to the foregoing, the price paid by the end user may reflect regulated charges, credits, discounts and rebates which apply at various stages in the gas supply chain. Likewise, the transaction might also include fees and rebates associated with a credit card provider.

Thus, in this example the existing paradigm's cost recovery system must account for: (1) the extraction of crude oil from the ground, (2) the transport of said crude oil to refineries, (3) the storage of gasoline refined from said crude oil at the refineries, (4) the transport of the refined gasoline bulk storage terminals through pipeline facilities, tankers, or barges, (5) the storage of the gasoline at bulk storage terminals, (6) the transport of said gasoline to dispensing stations (or “gas stations”) in tanker trucks, and (7) the storage, sale and dispensing of the gasoline at gas stations. Despite subsequent advances in certain manners of wholesale transactions, fuel supply methods, and information technology, this complex system has prevailed largely unchanged to this day.

Today, however, wholesale transactions for energy products suitable for vehicles and energy product supply methods reflect that commodity brokers have a broad range of sourcing options. Those options have expanded greatly since the existing “pay at the pump” paradigm was organized. Now, energy product distribution/marketing networks recognize that a wholesaler can “introduce” a quantity of a “fungible commodity,” such as gasoline or electricity, at one location in the supply chain. That wholesaler can then exchange its right to that commodity for the right to extract that quantity from multiple locations connected to the supply chain.

Advances in information technology tools also potentially present avenues through which the existing paradigm for the purchase and delivery of energy products can be altered or abandoned. U.S. Pat. No. 7,840,446, issued Nov. 23, 2010, shows a stored value transaction system including an integrated database server. That computer based system utilizes database server which supports a number of stored value products, each of which correspond to financial products offered to customers by financial institutions. This allows end users to interact with the server in order to redeem said stored value.

There is therefore a need for a system and method that accounts for the improvements made and efficiencies introduced in the wholesale transaction, energy product supply, and information technology aspects of the sale and delivery of energy products for vehicles to end users.

Described herein is a system and method which meets these needs and removes the assumed requirement that automotive users must “pay at the pump” by creating an on-line exchange and reservation network which will allow end user and filling/charging station participants in an energy product acquisition and distribution process to conduct their transactions more efficiently and transparently. In addition, the system monitors changes in conditions and circumstances at the facilities where the commodity is processed, stored or transported, and provides real-time reports of such changes to the system's Administrators.

### SUMMARY OF THE INVENTION

A system and method comprising an administrator computer system, a network of filling/charging stations participants, and a network of end user participants. The system and method allows end users to effectively purchase fractionalized energy products for their vehicle on-line at any time and filling/charging stations to avail upon request or by schedule quantities of energy products to end users which correspond to the end user's fractionalized purchases. The administrator computer system may be defined by a Marketing, Accounting, and Distribution Computer System (“Administrator System”) which unbundles the various components of a traditional vehicle energy product purchase transaction. In this regard, the Administrator System allows an “end user” (meaning a consumer or organization consisting of many consumers) to separate the energy purchase decision from the time and place where that end user takes delivery, thereby increasing the end user's choices and flexibility. This is because the system described herein allows an end user to initiate requests for and purchases of energy products at times and locations other than the moment the energy product is needed and/or directly from the filling/charging station at which he or she takes delivery of that product.

Moreover, this system and method will allow an end user to maintain an “inventory” of gasoline, and add to or withdraw from that inventory at will without regard to the limits of his or her vehicle's fuel tank (or battery, or other energy product storage device). Indeed, the End User will be able to make actual or physical withdrawals of the user's energy product inventory from a network of providers which may be defined as filling stations (for gasoline or other fuel) or charging stations (for electricity), with the providers maintaining an account with the Administrator System to allow them to be replenished or compensated for the energy product that they provide.

A key component of the Administrator System is that it separates the “commodity price” component of an energy acquisition transaction from those components associated with the transportation, storage, distribution, and dispensing. Thus, in a gasoline example, instead of paying a price, “X” for a gallon of gas at a traditional gasoline station, the end user will pay: (1) a commodity seller an amount, C, for the each gallon of gasoline, (2) a system administration fee, A, for coordinating transportation, distribution, and storage, as well as for maintaining Administrator System accounting and ensuring that the commodity will be readily and efficiently available where and when the end user wishes to take delivery, and (3) the filling station operator at which the end user takes delivery a fee, S, for serving as a point of storage and dispensing.

Also, by separating the End User's purchasing decision from those regarding the delivery and dispensing, the Administrator System will function in a manner which allows End Users to pool their purchasing power. Looking back at the gasoline example, this will allow End Users to pay “fleet” prices for gasoline, rather than pay the usually marked up retail price charged at individual gasoline service stations. Moreover, End Users will be able to make gasoline purchase decisions at a time and place other than at the pump. Thus, End Users will be able to avoid the problem of paying a retail price of $3.50 for gas and then pass another station where the same grade of gas has a posted retail price of $3.25.

An object of this disclosure is to utilize a computer system to enhance a commodity distribution system's efficiency by providing a processing means: (1) for receiving and fulfilling multiple orders and reservations from multiple End Users for various grades and quantities of a commodity, and allowing those End Users to specify a variety of times and locations for delivery, (2) to aggregate and sort various End Users' orders into homogeneous lots of sufficient quantity and definition to correspond to quantities and qualities which are traded on a national or international commodity exchange, (3) for maintaining a Administrator System of reservations for End Users and Providers so as to minimize Administrator System congestion and to maximize Administrator System throughput and Administrator System utilization, (4) for monitoring the status and costs associated with operating the various facilities involved in a functionally and geographical diverse network which features facilities for commodity refinement, transportation, distribution and consumption, and (5) for balancing inventories in a commodity production, refinement, distribution and consumption network so as to maximize the efficient use of Administrator System facilities.

It is another object of this disclosure to enhance such an Administrator System's transactional fairness and accessibility by providing: (1) a method for End Users to make decisions about commodity purchases at a time and place which may differ from the time and place where the commodity is ultimately consumed, (2) a method for aggregating End Users' commodity purchases so as to allow End Users to participate in various contracts at wholesale, and (3) a method for facilitating and monitoring changes in ownership of fractional shares of a bulk-purchased commodity between the time of the original acquisition of that commodity and the time when transaction participants take physical delivery of the commodity.

Another objective of this disclosure is to accommodate complex accounting, financial, legal and regulatory constraints by providing: (1) a method for managing the financial aspects of an Administrator System for receiving and fulfilling orders for the delivery of a commodity which has a highly volatile price or value, (2) a method for a wholesale commodity transaction to be decomposed efficiently and economically and in a manner which allows persons who participate in the transaction to engage in post-acquisition trades of fractional shares of that commodity prior to taking physical delivery of the commodity, (3) a method for confirming that trades in fractional shares of a commodity purchase conform to the requirements of federal, state, and local laws in the jurisdictions where the transactions are deemed to have occurred, (4) a method to account for various quantities and volumes of a commodity which are introduced into a distribution system or withdrawn from that distribution system, and (5) a method for managing and allocating credits, rebates and discounts.

It is yet another object of the present disclosure to provide a method for making underlying transactions and planning transparent from the perspective of the End User.

Another object of the present disclosure is to provide a method for making transactions secure and confidential.

It is another object of this disclosure to provide a method for facilitating any End User's projections of that End User's future commodity needs.

These and other objects will be apparent to one of skill in the art.

### BRIEF DESCRIPTION OF THE DRAWINGS

FIG. 1 shows an entity communication diagram for the parties affected by the present invention.

FIG. 2 shows a general process flow chart of a traditional gasoline production model.

FIG. 3 shows a price breakdown diagram of a traditional gasoline price model.

FIG. 4 is a receipt and processing of end user requests flow chart for a system built in accordance with the present invention.

FIG. 5 is processing of reservation requests with all parameters specified flow chart for a system built in accordance with the present invention.

FIG. 6 is an order fulfillment process flow chart for a system built in accordance with the present invention.

FIG. 7 is a delivery and settlement process for a system operated dispensing station flow chart for a system built in accordance with the present invention.

FIG. 8A shows a partial view of an alternate embodiment of a delivery and settlement process for a non-system operated dispensing station flow chart for a system built in accordance with the present invention.

FIG. 8B shows a partial view of an alternate embodiment of a delivery and settlement process for a non-system operated dispensing station flow chart for a system built in accordance with the present invention.

FIG. 9 shows an order pooling and allocation diagram for a system built in accordance with the present invention.

FIG. 10 shows a purpose overview flow chart for a system built in accordance with the present invention.

### PREFERRED EMBODIMENT OF THE INVENTION

In April 1985, the Federal Energy Regulatory Commission (“FERC”) adopted its Order No. 436, thereby establishing a voluntary “open access” transportation program for natural gas markets. A key aspect of that program was that natural gas market participants were able to “unbundle” energy costs, meaning they were able to separate the cost of producing and processing natural gas from the costs associated with transporting that gas from the point of production to the point of consumption. Thus, the open-access program allowed natural gas pipeline operators to offer transportation services not linked to gas commodity sales service. That program also allowed utilities and large volume energy customers to purchase natural gas directly from producers and/or marketing companies. In turn, those customers paid pipeline operators separately to transport the commodity to the point of consumption.¹ ¹See http://www.pmel.org/NaturalGas Glossary.htm#436; see also http://www.energychoices.us/natural_gas.html.

The present disclosure extends that “unbundling” process to the refined petroleum and other energy product markets. To that end, in a gasoline example, the Administrator System takes advantage of computers and the Internet so as to manage the various parts of a gasoline purchase and distribution transaction. It does so in order to combine many End Users' purchase and distribution transactions so as to create beneficial economies of scale.

At the same time, the Administrator System recognizes that in the gasoline example, throughout the United States and elsewhere, governments have enacted or imposed statutes and regulations to manage the sale and distribution of gasoline. Thus, the Administrator System accommodates a heterogeneous fabric of laws which were designed to protect consumers and to reduce anti-competitive marketing arrangements. Indeed, by unbundling gas purchase, distribution and dispensing transactions, the Administrator System liberates those transactions from some aspects of the existing regulatory scheme, but implicates others to which such transactions were previously immune.

Sticking with the gasoline example, the various state and federal governments rely heavily upon tax revenues which gas sales generate; therefore, the method contemplates intrastate and interstate transactions which implicate a mélange of tax laws. The Administrator System recognizes that the End User may be deemed liable for a tax on the gas commodity in one state, even though the consumer may actually take delivery of that commodity in another. Likewise, the Administrator System recognizes that some but not all states have adopted provisions which outlaw “below-cost” sales (affecting gasoline and other commodities). The Administrator System takes such provisions into account and manages each End User's transaction so as to minimize the regulatory impact on cost.

Moreover, gasoline commodity sales contracts are the subject of terms and conditions established by self regulated financial exchanges such as the New York Mercantile Exchange and Chicago Board of Trade Likewise, the method assumes that End Users will ultimately use on line credit accounts and/or electronic funds transfers to pay for the commodities they purchase and services they require. Consequently, we have designed and are implementing the method under review to accommodate a complex collection of state and federal laws, as well as financial, institutional, and industrial arrangements.

A key to the present disclosure is that it alters a basic assumption upon which the prevailing “pay at the pump” paradigm is based. That paradigm gives energy product providers a heightened degree of control over the pricing options that consumers face. Likewise, it limits a consumer's purchasing decisions to the options available at the times and places where he or she can take delivery of an energy product. Moreover, the existing paradigm maintains an artificial barrier to transactions that can now be facilitated using the enhanced information the Internet provides.

The present disclosure recognizes that certain transactional, information technological, and energy product supply advances make it feasible for consumers to access energy product markets using the same techniques which are available to wholesalers. The only differences (between wholesalers and consumers) which are relevant relate to questions of scale. And, when consumers' purchasing decisions are pooled, they can eliminate the scale advantage that wholesalers now exploit.

The system and method disclosed herein employs social networking tools to that end. In the process, the system and method alters the now-outmoded paradigm. The instant system and method allows consumers to plan for and conduct their energy product purchases well in advance of the moment when, for example, the “E” light begins to flash on their cars' dashboards. Now, consumers can track movements in energy product prices on various commodity exchanges. When a price matches a consumer's expectations, that consumer can place an order using the Administrator System described herein. In turn, the Administrator System described herein bundles that consumer's order with those placed by the Administrator System's other customers. The Administrator System then executes these bundled orders by purchasing energy products from local, regional or national providers, depending upon the number of consumers participating and other market conditions.

Once the Administrator System obtains an energy product to “energize” a consumer's order, the Administrator System then processes the order so as to allow that consumer to take delivery of his or her energy product from a dispensing station at a convenient time and location. The process the Administrator System employs to select one or multiple available dispensing stations will depend upon several variables. One set of variables is determined by the time frame the consumer specifies within which he will take delivery after placing the order. Another set of variables will be determined by the location where the consumer specifies she is likely to take delivery. Yet another set of variables is determined by (a) the number of network dispensing stations, namely dispensing stations that are controlled or otherwise participating with the Administrator System on a fixed, predetermined set of terms that the Administrator System has established in the consumer's delivery area; or (b) the type of relationships the Administrator System has established with “non-network” dispensing stations within that area. It is contemplated that for both network and non-network dispensing stations and non-network dispensing stations, a Fulfillment and Settlement Module may be available as a pre-programmed computer device or software program (or a webpage interface) that operates on a computer at the dispensing station to allow the dispensing station to make arrangements to be compensated with funds or replenished with energy product for each instance of an energy product being distributed to an end user.

The Administrator System makes it feasible for End Users to combine their purchasing power so as to take advantage of opportunities to purchase an energy product (and related services) at wholesale prices at local, regional or nation markets. For instance, 42,000 gallons is the standard volume for a “New York Harbor RBOB Gasoline (Physical) futures . . . gasoline contract between a buyer and a seller” on the New York Mercantile Exchange.² If we assume that the typical End User takes delivery of 15 gallons at a time, then the Administrator System would need to bundle together 2800 End User Reservation Requests (“EURRs”) for gasoline to support one order on the NYMEX. ²See NYMEX Rulebook, Chap. 191, Sec. 191.02, published at http://www.cmegroup.com/rulebook/NYMEX/1a/191.pdf.

Keeping with a gasoline example, so long as individual End Users purchase gas in the traditional manner, their transactions will be of insufficient size to take advantage of the wholesale markets. However, the Administrator System restructures the traditional marketing arrangement so that End Users gain the ability to join together more efficiently. Thus, the Administrator System's basic function will be to take multiple End Users' reservations for pre-purchased quantities of gas and to make arrangements for such users to take delivery at times and places the End Users will specify. The Administrator System will then aggregate such reservations to build a contract to purchase gas on an exchange such as the NYMEX.

Still, the ability to participate in a wholesale commodity purchase will be of little practical value unless an End User has a mechanism for taking delivery of his share of the contracted volume. To that end, the Administrator System will offer End Users various alternatives. So in a gasoline example, when the End User registers a reservation with the Administrator System, it may create a corresponding reservation which resembles one of the following scenarios:

Scenario 1: Type of Gasoline=87 Octane; Quantity (gals.)=10; Brand=Shell; State=Florida; County=Broward; Dispensing Station=Pine Island & Broward; Pump=6; Week of Delivery=2011/17; Day of Delivery=Tuesday; Hour of Delivery=1500.

Scenario 2: Type of Gasoline=87 Octane; Quantity (gals.)=40; Brand=Unspecified; State=Florida; County=Broward or Miami-Dade; Dispensing Station=Unspecified; Pump=Unspecified; Week of Delivery=2011/18 to 2011/22; Day of Delivery=Unspecified; Hour of Delivery=Unspecified.

Scenario 3: Type of Gasoline=87 Octane; Quantity (gals.)=1000; Brand=Unspecified; State=Florida; County=Broward; Dispensing Station=Unspecified; Pump=Unspecified; Week of Delivery=Unspecified; Day of Delivery=Unspecified; Hour of Delivery=Unspecified.

Scenario 4: Type of Gasoline=87 Octane; Quantity (gals.)=20; Brand=Unspecified; State=Unspecified; County=Unspecified; Dispensing Station=Unspecified; Pump=Unspecified; Week of Delivery=2011/17; Day of Delivery=Tuesday; Hour of Delivery=1500.

These scenarios reflect the broad range and flexibility the Administrator System is designed to accommodate. Scenario 1 may resemble the traditional retail purchase transaction most closely. In this scenario, as she prepares her on-line reservation, the End Users specify all of the parameters for her gas purchase transaction. When the Administrator System accepts her reservation, it makes prepaid arrangements for the commodity component as well as the distribution, dispensing, tax and other components. Depending upon Administrator System loads, the End User may enjoy additional savings for specifying all parameters at the time of her order. Alternatively, if the EU has specified parameters that coincide with taking delivery during a peak demand period, then the Administrator System may require that EU pay a premium. In any event, under Scenario 1, after the Administrator System has accepted the EU' s reservation, the Administrator System will collect the applicable taxes and fees from the EU, and the EU may proceed to the designated dispensing station and take delivery.³ In anticipation, the Administrator System will make arrangements with the Dispensing Station to ensure that the EU's pre-purchased quantity is available as specified. That means that the Administrator System will pay the Distribution Component to the Jobber who supplies the DS Likewise, after the End User takes delivery, the Administrator System will pay the DS for that service. ³The Administrator System will also accommodate the circumstance where the EU cannot take delivery at the time and location she originally specified in her reservation.

As a practical matter, rather than make specific payments associated with individual deliveries at the time it accepts an EU's reservation, with regard to Jobbers, Dispensing Stations and/or Energy Product Wholesalers, the Administrator System may employ Fulfillment and Settlement Modules. These modules may be implemented on a computer system owned or controlled by the Jobbers, Dispensing Stations and/or Energy Product Wholesalers and will balance the Administrator System's Inventory and Accounting obligations at efficient intervals by either providing for the delivery of replacement energy product or by providing payment for the energy product.

While Scenario 1 closely resembles the traditional gas purchase transaction, an End User who wishes to take advantage of the Administrator System's flexibility may make arrangements resembling Scenario 2. Under this scenario, the End User merely purchases the right to withdraw 100 gallons of gas from any network Dispensing Station in Broward or Miami-Dade County during Week 17 in 2011. An End User might make such a reservation if he anticipates that during the month of May 2011, he will need to fill his car's tank in one county, and his son's tank in another. Because he is not certain when and where it will be convenient to take delivery, the End User crafts his reservation so as to retain the flexibility to take those deliveries at any station (regardless of brand). Later, the End User can log into the Administrator System and specify the remaining parameters. Alternatively, during May 2011, the End User or his son can drive to any network DS and take delivery. Should the month end before the End User can take delivery of all the gas he has purchased, the Administrator System will reflect that he retains a credit to withdraw the remaining volume from any DS in Broward or Miami-Dade County. However, the EU will forfeit any discounts he might have received as a result of specifying the temporal parameters when he originally made his reservation.

Whether an End User opts to make a reservation resembling Scenario 1 or Scenario 2, the Administrator System will process the resulting reservation by combining it with other EUs' order. Under Scenario 2, the Administrator System may accept the End User's reservation and bundle his request for 100 gallons with that of other End Users who have specified that they wish to take delivery of 87 Octane gas in South Florida during week 17. Assuming that End User's have specified a sufficient volume to complete a commodity purchase transaction, the Administrator System will then place an order for a contract with a Broker at the NYMEX.⁴ After the Broker notifies the Administrator System that it has arranged the RBOB futures contract, the Administrator System allocates the gallons within that contract to participating EUs' accounts. ⁴Even if the volume of gallons EUs has reserved is smaller than the NYMEX's minimum contract, the System may opt to proceed with a contract and allocate the remaining volume to its own account.

The scenarios described above illustrate how an End User might engage the Administrator System to purchase gasoline. In addition, the scenarios hint at some of the processes through which the Administrator System breaks the traditional retail gas purchase into its separate parts. Again, when we complete a traditional gas purchase, we are actually paying for the following: (1) a commodity price for gas, including the cost of extraction and refinement, (2) a fee for transporting the gas from the refinery to a local terminal, (3) a fee for distributing the gas from the local terminal to a dispensing service station, (4) a fee to cover the dispensing service station's operating costs, (5) a fee to cover the branding and marketing of the gas, and (6) taxes and inspection fees collected by local, state and federal governments.

Continuing in a gasoline example, in addition to the foregoing, the price we pay at the pump may reflect credits, discounts and rebates which apply at various stages in the gas supply chain Likewise, the transaction might also include fees and rebates associated with a credit card provider.

As it handles the End Users' reservation and/or delivery transactions, the Administrator System must account for such fees and costs, albeit at wholesale rather than retail levels. That accounting becomes somewhat more complicated when the EU retains the flexibility to specify the location parameters after making his reservation. In that instance, the Administrator System will only be able to determine the taxes which apply after Administrator System has identified the DS at which the EU has taken or will take delivery. Thus, when an EU makes his reservation, the Administrator System may provide an estimate of the taxes that the EU is likely to be charged, but that estimate will be subject to a final settlement.

Likewise, until such time as the EU takes final delivery, the EU's charges for transportation, distribution and dispensing may remain undetermined. The EU may have specified the county in which he or she expects to take delivery. On that basis, the Administrator System may be able to provide firm estimates concerning the final transportation and distribution charges associated with a reservation. Nevertheless, until the EU actually takes delivery, the actual costs associated with the non-commodity components of the transaction will remain undetermined.

In addition, the Administrator System will need to maintain reserves with operators of a variety of branded dispensing stations. These reserves will allow End Users to have the flexibility to take delivery of gas at unspecified locations on the fly. Therefore, when an EU takes delivery of 15 gallons at a Mobil station, the Administrator System can direct the DS operator to debit the Administrator System's account for the gas the EU has received. In turn, the Administrator System will adjust the EU's account to reflect that the EU has used his right to withdraw 15 gallons from the Administrator System. Similarly, the Administrator System will make adjustments to cover the remaining cost components associated with the EU's purchase and delivery.

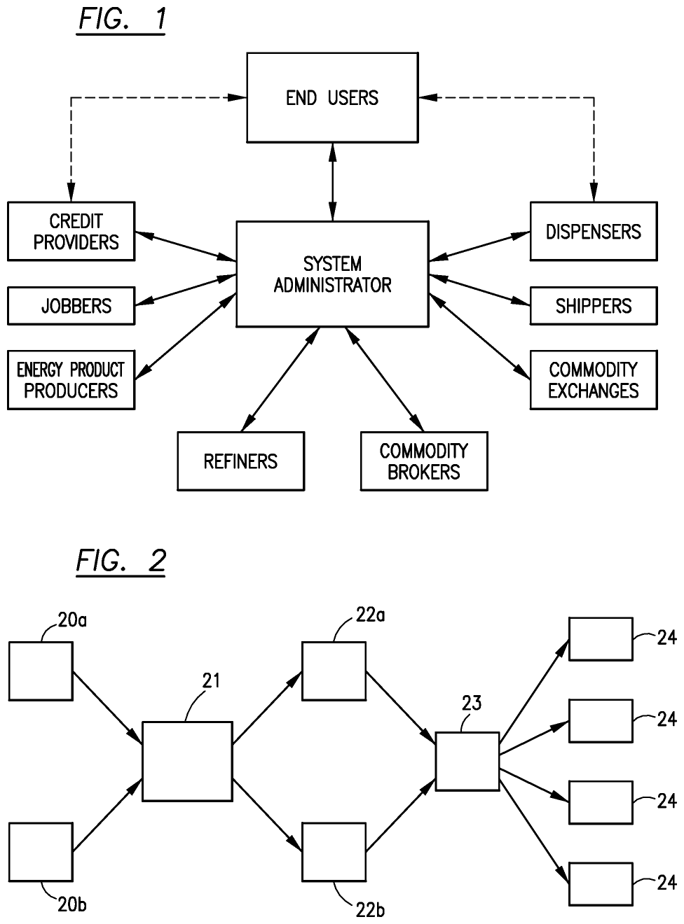

Referring now to the drawings and in particular FIG. 1, the Administrator System (or “Administrator”) is at the center of all interaction in the instant system and business method. The Administrator, which may be defined as a computer network accessible computer or multiple computer network accessible computers operating together, is responsible for receiving and fulfilling orders placed and reservations made by the End Users. The Administrator will do so by completing commodity purchases employing the services of commodity brokers, by reserving Administrator System resources to allow the purchased commodity to be stored, transported, distributed and dispensed, and by maintaining records and accounts reflecting these processes Likewise, the Administrator maintains an exchange which allows End Users to trade their fractional interests in previously ordered commodities and/or reserved services. To these ends, the Administrator maintains relationships with: (A) Brokers, who conduct transactions on the Administrator's behalf at Commodity Exchanges such as the NYMEX or Chicago Board of Trade, (B) Petroleum Refiners⁵, (C) Petroleum Transporters and Carriers, such as Colonial Pipeline, Buckeye Partners, L.P. and Citgo Petroleum Corporation, (D) Local Terminal Facilities, (E) Local Distributers/Jobbers, (F) Local Dispensing Stations (which may be referred to as “service stations,” “filling stations,” and/or “charging stations”), and (G) End Users. ⁵See http://www.eia.doe.gov/nei/rankings/refineries.htm

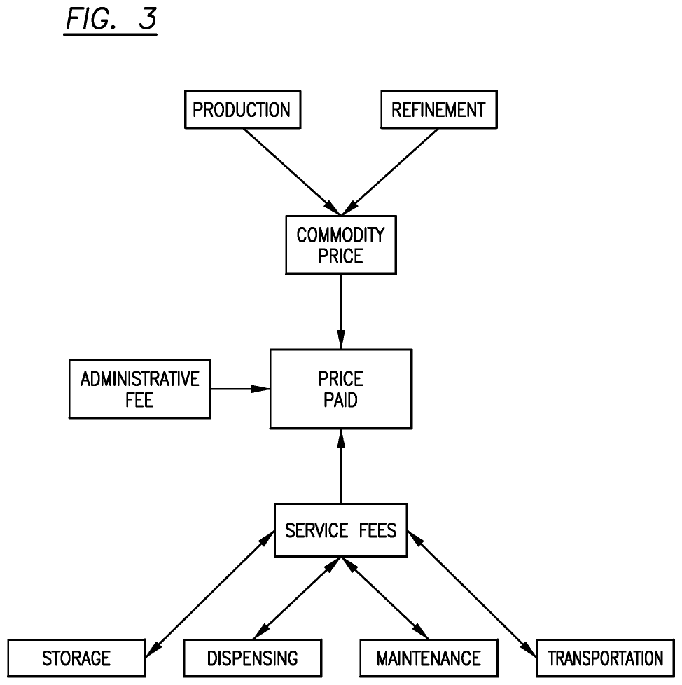

Referring now to FIG. 2, looking to gasoline purchasing as an example, the steps at present time through which crude oil is refined into refined gasoline and transported to stations to be dispensed to End Users are shown. Generally, the process begins with the importation of imported crude oil 20a or the extraction of domestic crude oil 20b (collectively “20”). Next the crude oil 20 is sent to a refinery 21 where it is refined. The refined fuel is then transported to either a pipeline storage facility 22a or kept at a refinery storage facility 22b. From pipeline storage facility 22a, the fuel can be piped to a bulk storage terminal 23. From a refinery storage facility 22b, the fuel is typically sent by tanker or barge to the bulk storage facility 23. From the bulk storage facility 23 tanker trucks typically deliver the fuel to fuel to a plurality of fueling stations 24. The fueling stations 24 are where the user typically is able to pay for and take delivery of fuel at the time it is necessary or desired.

In a comparable gasoline purchasing example, the system and method of the instant disclosure operates within the existing confines of these general steps, but works to offer End Users the ability to pool their purchases in order to purchase fuel at the commodity price and pay separately for the other components associated with the production, refinement, transportation, storage, and dispensing that comprise the price of gasoline under the existing pay at the pump system.

The core of the Administrator System includes and utilizes the following components:

A. A network accessible computer system (having various components similar to those claimed in the Stored Value System), including:
1. Data structures; various.
2. Computational Facilities; various.
   a. Clients, stationary and mobile.
   b. Servers.
   c. Processors.
3. Communication Devices; various.
4. Databases and Data Storage.
5. User Interface Devices.
   a. Data Entry Devices; various.
   b. Data Display Devices; various.
6. Financial products.

The Administrator System interacts with and makes use of the components of the overall traditional automotive fueling set up. Such interaction includes and/or makes use of:

A. Commodities, such as gasoline.

B. Communication Interfaces; various.
1. Mobile handsets communicating with cellular telephone networks.
2. Point of Sale Terminals.

C. Physical Status Monitoring Devices
1. The system includes devices which monitor:
   a. Location of moving tanks.
      (1) Shipping tanks.
      (2) Jobber tankers.
      (3) End User vehicle tanks.
   b. Quantities.
      (1) Oilfield Production.
      (2) Shipping tank levels.
      (3) Refinery Output.
      (4) Pipeline Levels.
      (5) Tank Farm tank levels.
      (6) Jobber tanker levels.
      (7) Dispensing station tank levels.
      (8) End User tank levels.
   c. Queuing order and wait times.
      (1) Shipping tanks; loading and unloading.
      (2) Jobber tankers; loading and unloading.
      (3) End User vehicle; at dispensing stations.
   d. Temperatures; various.
   e. Barometric Pressure; various.

D. Commodity Processing Facilities.
1. Refineries

E. Commodity Terminal/Storage Facilities
1. Storage Terminals and Tanks.
2. Fueling Racks.
3. Pipelines.

F. Commodity Distribution Facilities and Facilitators. Generally, in Florida and elsewhere, persons who supply or store gasoline must have a license. These licensees include:
1. Pipelines.
2. Terminal Operators.
3. Railroads.
4. Tanker Ships and Barges.
5. Jobbers.

G. End User Order Processing Facilities
1. Desktops.
2. Mobile Telephone Headsets.
3. Laptop/Notebook/Tablet Computers.
4. On-board Vehicle Communication Devices (which monitor the vehicle's fuel tank level).

H. Commodity Dispensing Facilities (Service Stations).
1. Real Estate.
2. Storage Tanks.
3. Fuel Dispensing Terminals.
4. Communication Interface.

In a gasoline example, the End User exchanges credits with the Administrator System for delivery of Gas. The End User will use the Administrator System for three main purposes, namely to (a) acquire the right to take delivery of gas, (b) locate nearby or otherwise convenient DSS's at which the EU may take delivery of Gas, and (c) exchange credits for delivery of Gas. Incidentally, the EU will also be able to conduct other transactions or gather additional information, including but not limited to the following: (d) create and maintain an EU account, (e) check Gas Commodity prices, (f) check the status of EU and DSS inventories, (g) check servicing times at DSS's, (h) compare Administrator System prices with retail pricing, (i) plan future purchases and deliveries outside, and (j) trade inventories with and/or transfer gas to other members. The steps the Administrator System will use to complete these processes are described in greater detail below:

a. Process an End User's request to reserve a quantity of gasoline for delivery

b. EU locates nearby or otherwise convenient DSS's at which the EU may take delivery of Gas

c. EU creates and maintain an EU account

d. EU monitors Administrator System and Market Conditions.
i. EU checks Gas Commodity prices
ii. EU checks the status of EU and DSS inventories
iii. EU checks servicing times at DSS's
iv. EU compares Administrator System prices with retail pricing

e. EU plans future purchases and deliveries outside

f. EU trades inventories with and/or transfer gas to other members.

g. Administrator System Orders a RBOB Contract.

h. Administrator System Orders Transportation Services.

i. Administrator System Orders Distribution Services.

j. Administrator System Orders Dispensing Services.

k. Administrator System Reallocates an Unused Accepted EOS.

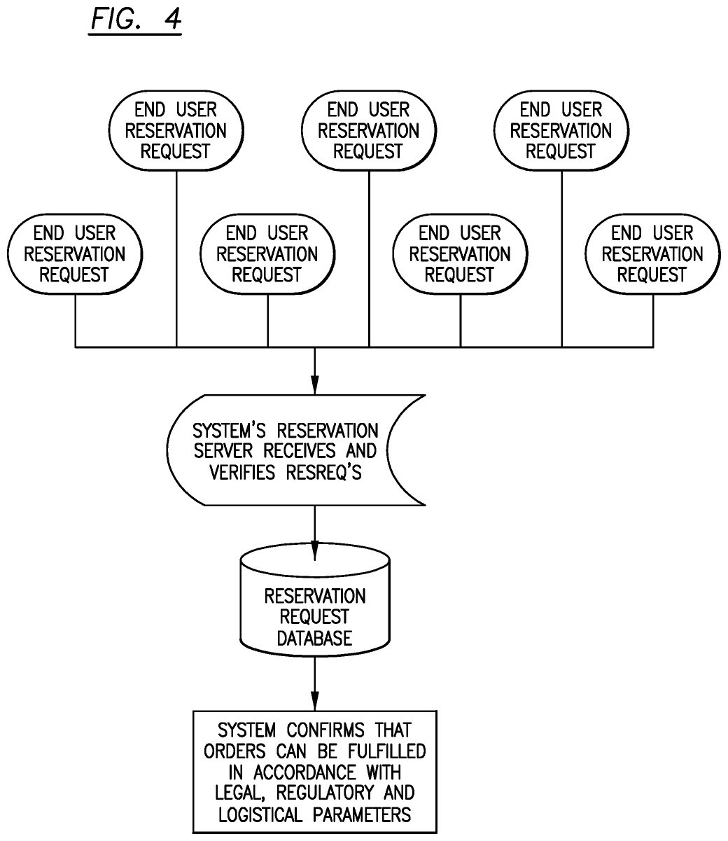

Referring now to FIG. 3, the manner in which the Administrator System in a gasoline example separates the commodity price component of gasoline purchase from those other components. The Administrator System allows an End User to pay: (1) a commodity seller an amount of gasoline (or right to withdraw a gallon of gasoline from ANY participating gasoline station), (2) a Administrator System a fee for coordinating product refinement, distribution, and storage, as well as for maintaining system accounting and ensuring that the commodity will be readily and efficiently available when the end user wishes to take delivery, and (3) the dispensing station operator at which the end user takes delivery a fee for serving as a point of storage and distribution.

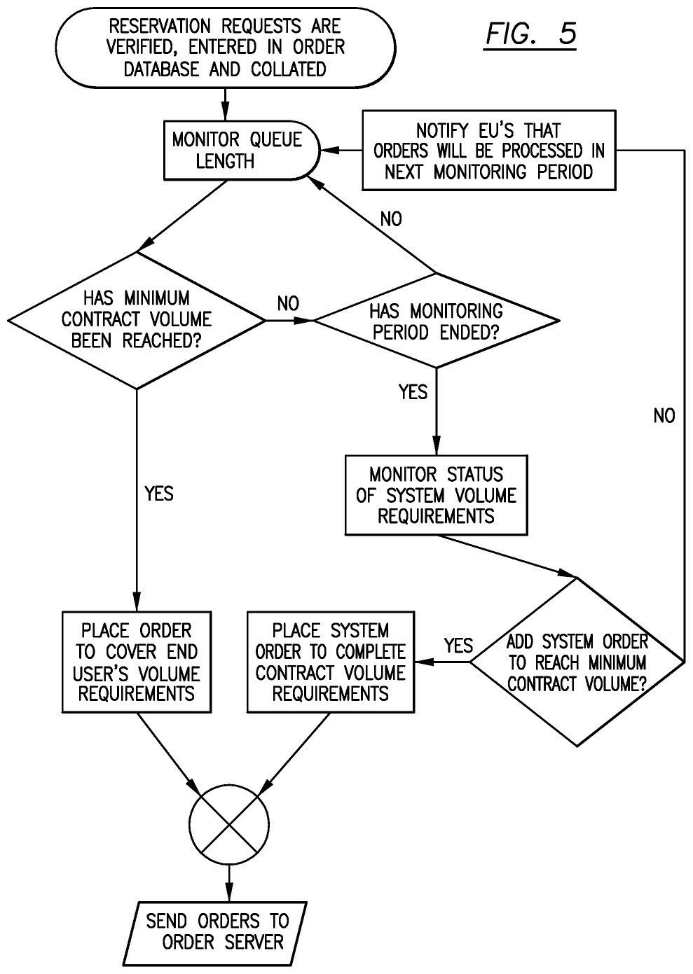

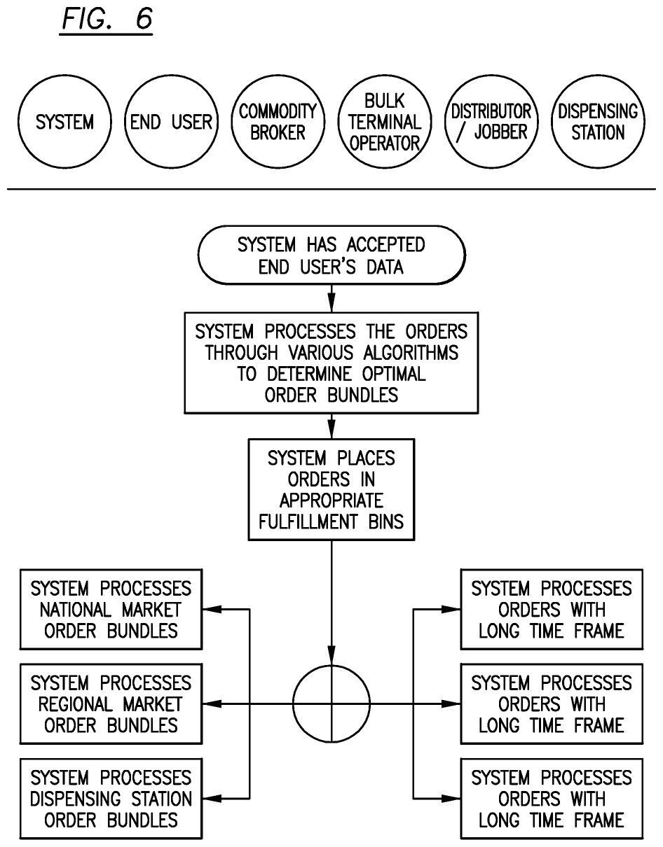

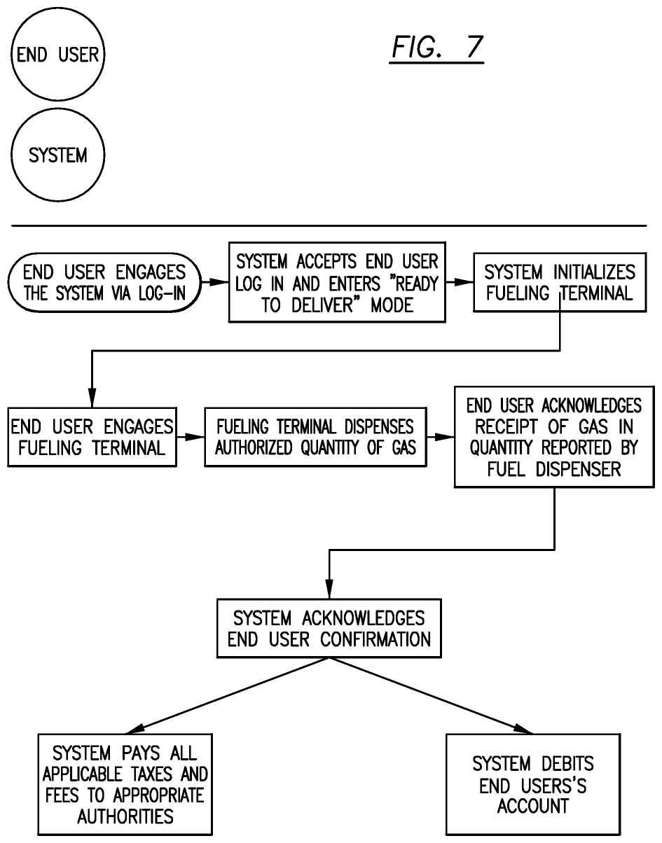

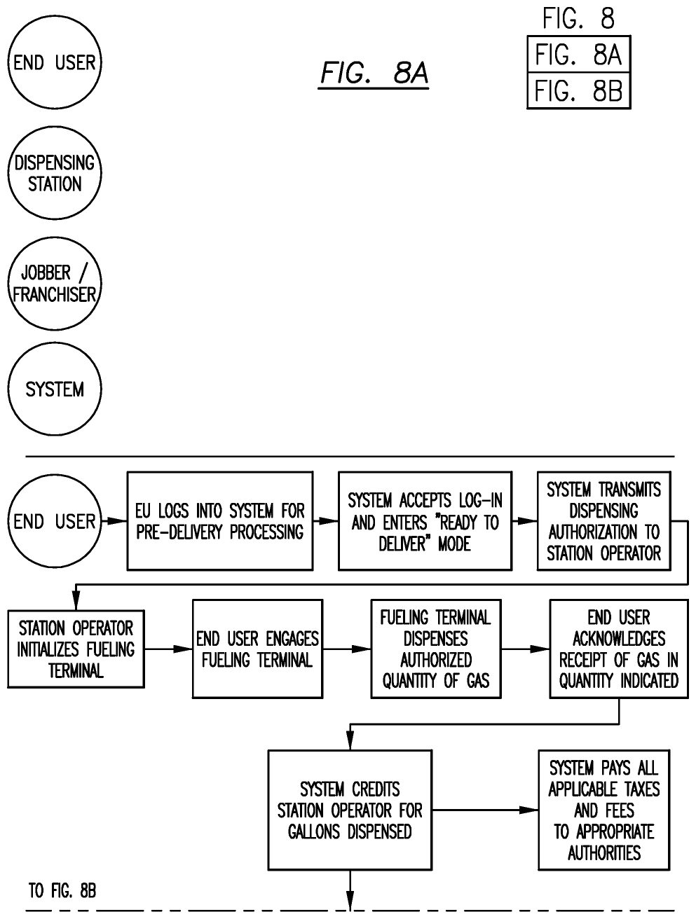

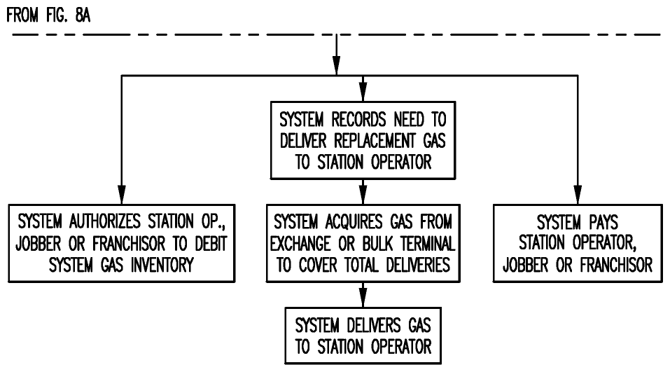

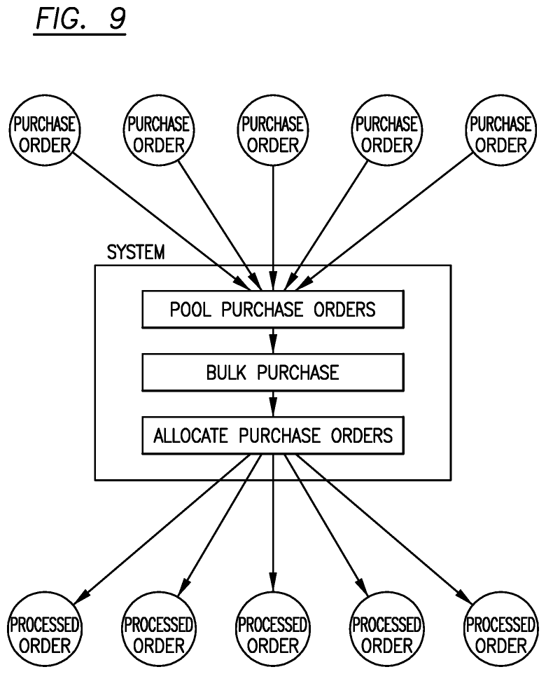

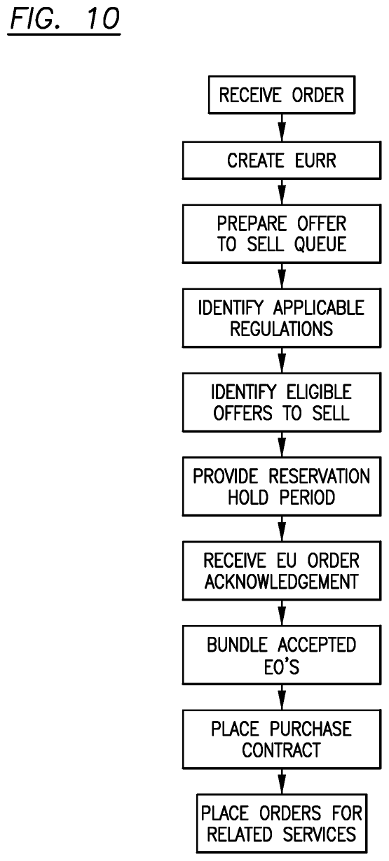

Referring now to FIGS. 4-10, the manner in which the Administrator System in a gasoline example processes an End User's request to reserve a quantity of gasoline for dispensing by a dispensing station operator at a dispensing station is shown in further detail. The order receipt and processing, processing of reservation requests with all parameters specified, order fulfillment, network operated dispensing station delivery/settlement, and non-network operated dispensing station delivery/settlement processes are as follows:

i. Place an Order:
(1) Automated Request per On-Board Vehicle Module.
   (a) The End User populates his or her profile with pre-need parameters detailing the circumstances under which the Administrator System will automatically proceed with an order on the End User's behalf. Such circumstances may include:
      (i) a specified schedule; or
      (ii) a signal from a module on-board an End User vehicle, whether a discrete preprogrammed computer system module that is communicatively coupled with the electronics system of a vehicle or software based module integral with the electronics system of a vehicle, indicating that the vehicle's fuel tank has reached a specified level. In order for this module to be effective, the End User will need to equip his vehicle with a device which maintains a communication link with the Administrator System. For example, such a device might consist of a Bluetooth enabled addition to the vehicle's fuel gauge which communicates with the Administrator System via the End User's cellular telephone. That device might also specify the vehicle's location at the time the signal is sent, thereby allowing the Administrator System to locate any nearby Dispensing Stations. The Administrator System would, in turn, advise the End User using an SMS or other message regarding the location of the most convenient Dispensing Station at which the End User might take delivery of an energy product.
   (b) When the triggering event occurs (such as when the Administrator System receives a message from the on-board device), the Administrator System proceeds with a Reservation Request using parameters previously recorded in the End User's profile.
   (c) Thereafter, the Administrator System processes the Reservation Request as specified below.
(2) Manually entered Reservation Request.
   (a) After logging into the Administrator System, the EU allows the Administrator System to detect the EU's physical location, and then confirms that location.
   (b) The EU selects the type of transaction the EU would like to complete, namely “Gas Purchase.”
   (c) The EU specifies transaction parameters.
      (i) The Administrator System provides the EU with a list of options to specify where the EU is likely to take delivery of the Gas. (“Non-specified DSS” will be an option.)
      (ii) The Administrator System provides the EU with a list of options to specify the when the EU is likely to take delivery of Gas. (“Non-Specified Delivery Time” will be an option.)

ii. Using the EU's responses, the Administrator System creates an “EU Reservation Request” (or “EURR”).
(1) The Administrator System creates an EURR (which actually consists of a set of EURR's for each part of the transaction) by processing the EU's profile, credit history and location of EU at the time of transaction, as well as any additional variables the EU has specified, such as, location of proposed delivery, time frame for delivery.
(2) The Administrator System classifies the EURR and processes it accordingly.
(3) The offer might reflect a reservation to take delivery of a specified amount at a specified network DSS at a specified location within a specified time frame, coinciding with unsold and unreserved inventory that the DSS already has on hand. As such, the offer would include a Administrator System fee, commodity price, a jobber delivery fee, dispensing fee, and all applicable taxes and other fees.
   (a) The Administrator System queries its own inventory to determine whether it has any resources with which to satisfy the EURR.
      (i) If the Administrator System has inventory that satisfies the EURR, the Administrator System makes an intra-system EPO and reservation.
      (ii) If the Administrator System lacks sufficient inventory to satisfy the EURR, the Administrator System either initiates the acquisition of additional Administrator System resources, or attempts to satisfy the EU's request through another provider.
      (iii) The Administrator System queries other DSS's in the relevant market to determine whether they have inventory with which to meet the EU's need.
      (iv) If sufficient resources cannot be immediately identified inside or outside of the Administrator System within a specified time frame, the Administrator System advises the EU and asks the EU whether the Administrator System should continue attempts to fulfill the EU's request over a longer period of time.
   (b) The EURR might also reflect the right to take a specified amount of gas from an unspecified network DSS within a specified delivery area within an unspecified time frame. As such, the offer would include only an Administrator System fee, a commodity price and all applicable taxes. The jobber delivery fee, dispensing fee and other fees would be determined at the time of delivery.
   (c) Likewise, the EURR might reflect the right to withdraw a specified volume from any network DSS. As such, the offer only would reflect an Administrator System fee and a commodity price. In turn, the Administrator System would determine all applicable taxes, the jobber delivery fee, dispensing fee and other fees at the time of delivery, depending upon the location at which the EU takes delivery.

iii. The Administrator System prepares a query to identify “Offers to Sell” from gas commodity providers (including network and non-network commodity sources) that might satisfy the EURR. The Offers to Sell may include all levels of the transaction (i.e., commodity, transportation and distribution, and dispensing).

iv. The Administrator System uses its Regulatory Module to identify the Regulations which the EURR might implicate.
(1) The Administrator System identifies the State where the commodity transfer will be deemed to have taken place.
(2) The Administrator System identifies the State where the EU will take delivery of the Gas.
(3) The Administrator System identifies the taxes (i.e., jurisdiction and rate) which it must collect in connection with the EU's Gas purchase.

v. The Administrator System identifies any existing internal or external

“Eligible Offer to Sell” (an “EOS”) which meet might the requirements of the EURR and comply with applicable regulations.
(1) In this step, the Administrator System compares the EURR with existing Administrator System resources to classify it as a request (a) to reserve a number of gas units from previously unsold inventories, (b) to participate in a previously scheduled but incomplete purchase, or (c) to initiate the scheduling of a new purchase to be fulfilled using external sources.

vi. During a “Reservation Hold Period,” the Administrator System allows the

EU an opportunity to review and select the relevant EOS's. Meanwhile, the Administrator System allows other EU's to join a queue to take advantage of any EOS which might meet their EURRs. The Administrator System will deem as rejected any EOS the EU fails to select affirmatively within the Reservation Hold Period. Then, the EOS is associated with another EURR for another Reservation Hold period.
(1) Each EOS is associated with a “Reservation Hold Period.”
(2) Within the designated Reservation Hold Period, the Administrator System maintains a tentative reservation with regard to the commodity, as well as any associated delivery and dispensing services. While so doing, the Administrator System continues to manage the Administrator System's loads to avoid excessive over-booking and to ensure that Administrator System capacity will not be exceeded beyond a tolerable limit. Further, it continues serving other EUs' requests for EPO's. Moreover, the Administrator System recognizes that the various components of the transaction are sequentially dependent upon each other and keeps the components in balance while waiting for final settlement of EPO's. Therefore, even though a particular EU may not have specified the DSS at which that EU will take delivery of a specified quantity of gas, the Administrator System takes into account and manages the possibility that any EPO might yield an “over booked” scenario.
(3) The Administrator System reports each EOS to the EU and waits for the EU's response.
(4) The Administrator System either marks an EOS as accepted or rejected.
   (a) Accepted EOSs are assigned to for further processing with a view toward making an actual reservation.
   (b) Rejected EOSs are associated with the next EURR in the queue, if any.

vii. The Administrator System “bundles” or combines the Accepted EOSs with those of other EUs with a view toward arranging a unit order at the appropriate level.

viii. After the Administrator System has bundled sufficient Accepted EOSs to satisfy a contract, the Administrator System places a purchase contract with a Commodity Broker.

ix. Likewise, the Administrator System places orders for transportation, distribution and dispensing services to fulfill the Accepted EOS's. The order for dispensing services may be transmitted to a service station as an electronic signal which authorizes and instructs the service station to allows the dispersal of a specified quantity of fuel to a specific end user. The service stations may receive such a signal through the Fulfillment and Settlement Module

The Administrator System may maintain an inventory on account with a gas station operator, jobber or franchisor or provide for the delivery of gasoline to service station after the End User has completed the dispensing transaction. Alternatively, the Administrator System, per a pre-existing arrangement, may simply pay a discounted price to the service station at the time the End User originally submitted the Reservation Request or at the time the End User takes delivery. In any event, such fulfillment operations may be managed between the Administrator System and any given service station through a Fulfillment and Settlement Module operating on a computer system being used or controlled by that service station.

In a typical arrangement, the Fulfillment and Settlement Module may allow for the service station operator to transmit a replenishment request as an electronic signal to the Administrator System in order to initiate the fulfillment operations of the Administrator System.

The Fulfillment and Settlement Module may additionally provide a real time update of a relevant service station's total inventory of energy product on site, the quantity of reserves that the Administrator System's has at the relevant service station, or both, by sending an electronic signal to the Administrator System. It is appreciated that such real time information may allow the Administrator System to avoid sending authorizations to service stations authorizing the dispersal of a specified quantity of fuel that the service station may not have available (either generally or to the relevant end user). It is appreciated that such real time information may also, for example, assist the Administrator System in providing End Users with the flexibility to take delivery of gas at unspecified locations on the fly by allowing the Administrator System to provide information to End Users about available inventory.

The instant invention has been shown and described herein in what is considered to be the most practical and preferred embodiment. It is recognized, however, that departures may be made from within the scope of the invention and that obvious modifications will occur to a person skilled in the art.

What is claimed is:

1. A system for managing the aggregated purchase and fractionalized dispersal of energy products for vehicles, comprising:
an administrator computer system accessible over a computer network;
a plurality of vehicle modules, each associated with a corresponding vehicle, wherein each respective vehicle module in the plurality of vehicle modules is communicatively connected with said administrator system and configured to transmit a requirement signal relating to a desired energy product to said administrator computer system;
at least one dispensing station module associated with at least one dispensing station that is adapted to authorize a dispersal of an available energy product, wherein said at least one dispensing station module is communicatively connected with said administrator system and is configured to receive a plurality of electronic fulfillment authorizations from said administrator computer system;
wherein said administrator system is configured to manage an aggregate purchase of the desired energy product based on input from the plurality of vehicle modules and the authorization of fractionalized dispersals of a fulfillment energy product by performing the steps of:
(a) upon receipt of the requirement signals from at least two of the plurality of vehicle modules, generating a reservation request in response to each requirement signal, wherein each of the generated reservation requests identifies at least a type and a quantity of the desired energy product;
(b) aggregating the generated reservation requests into a homogeneous lot based on the type of energy product;
(c) purchasing a wholesale quantity of the type of energy product identified in the generated reservation requests which were aggregated into the homogeneous lot through a commodity transaction;
(d) calculating a commodity price relating to the type and the quantity of the desired energy product for each of the generated reservation requests which were aggregated so as to fractionalize a cost for each generated reservation request which was aggregated into the homogeneous lot;
(e) for each respective generated reservation request for which the commodity price was calculated, transmitting at least one of the plurality of electronic fulfillment authorizations to the at least one dispensing station module the so as to authorize localized dispersal of a fulfillment energy product out of the available energy product that corresponds to the type and the quantity of the desired energy product in the generated reservation request.

2. The system for managing the aggregated purchase and fractionalized dispersal of energy products for vehicles of claim 1, wherein the requirement signal additionally includes data relating to the physical location of the corresponding vehicle.

3. The system for managing the aggregated purchase and fractionalized dispersal of energy products for vehicles of claim 1, wherein each of the generated reservation requests additionally identifies at least one of a legal jurisdiction where a transaction for transfer of the desired vehicle fuel will be deemed to have taken place and a legal jurisdiction where the desired vehicle fuel will be delivered.

4. The system for managing the aggregated purchase and fractionalized dispersal of energy products for vehicles of claim 3, wherein said administrator system additionally performs the step of determining the taxes which must be collected in connection with each of the generated reservation requests.

5. The system for managing the aggregated purchase and fractionalized dispersal of energy products for vehicles of claim 1, wherein the requirement signal from at least one of the plurality of vehicle modules includes data relating to at least one of a fuel level and an energy level of the corresponding vehicle.

6. The system for managing the aggregated purchase and fractionalized dispersal of energy products for vehicles of claim 5, wherein the requirement signal from at least one of the plurality of vehicle modules is transmitted automatically based on the at least one of the fuel level and the energy level falling below a predetermined threshold.

7. The system for managing the aggregated purchase and fractionalized dispersal of energy products for vehicles of claim 1, wherein the requirement signal from at least one of the plurality of vehicle modules is transmitted automatically based on a predetermined schedule.

8. The system for managing the aggregated purchase and fractionalized dispersal of energy products for vehicles of claim 1, wherein said at least one dispensing station module is additionally configured to transmit a replenishment signal to said administrator system related to any localized dispersal of said fulfillment energy product.

9. The system for managing the aggregated purchase and fractionalized dispersal of energy products for vehicles of claim 1, wherein said fulfillment energy product is less than or equal to the quantity of the desired energy product in the generated reservation request.

10. The system for managing the aggregated purchase and fractionalized dispersal of energy products for vehicles of claim 1, wherein said fulfillment energy product is equal to the quantity of the desired energy product in the generated reservation request.

11. A system for managing the aggregated purchase and fractionalized dispersal of energy products for vehicles, comprising:
an administrator computer system accessible over a computer network;
a plurality of vehicle modules, each associated with a corresponding vehicle, wherein each respective vehicle module in the plurality of vehicle modules is communicatively connected with said administrator system and configured to transmit a requirement signal relating to a desired energy product to said administrator computer system;
at least one dispensing station module associated with at least one dispensing station that is adapted to authorize a dispersal of an available energy product, wherein said at least one dispensing station module is communicatively connected with said administrator system and is configured to receive a plurality of electronic fulfillment authorizations from said administrator computer system;
wherein said at least one dispensing station module is configured to provide a real time energy product level status which defines at least a quantity of energy product reserves available to the Administrator System at the at least one service station with which said at least one dispensing station module is associated;
wherein said administrator system is configured to manage an aggregate purchase of the desired energy product based on input from the plurality of vehicle modules and the authorization of fractionalized dispersals of a fulfillment energy product by performing the steps of:
(a) upon receipt of the requirement signals from at least two of the plurality of vehicle modules, generating a reservation request in response to each requirement signal, wherein each of the generated reservation requests identifies at least a type and a quantity of the desired energy product;
(b) aggregating the generated reservation requests into a homogeneous lot based on the type of energy product;
(c) purchasing a wholesale quantity of the type of energy product identified in the generated reservation requests which were aggregated into the homogeneous lot through a commodity transaction;
(d) calculating a commodity price relating to the type and the quantity of the desired energy product for each of the generated reservation requests which were aggregated so as to fractionalize a cost for each generated reservation request which was aggregated into the homogeneous lot;
(e) for each respective generated reservation request for which the commodity price was calculated, and using the energy product level status, transmitting at least one of the plurality of electronic fulfillment authorizations to the at least one dispensing station module the so as to authorize localized dispersal of a fulfillment energy product out of the available energy product that corresponds to the type and the quantity of the desired energy product in the generated reservation request.

12. The system for managing the aggregated purchase and fractionalized dispersal of energy products for vehicles of claim 11, wherein the requirement signal additionally includes data relating to the physical location of the corresponding vehicle.

13. The system for managing the aggregated purchase and fractionalized dispersal of energy products for vehicles of claim 11, wherein each of the generated reservation requests additionally identifies at least one of a legal jurisdiction where a transaction for transfer of the desired vehicle fuel will be deemed to have taken place and a legal jurisdiction where the desired vehicle fuel will be delivered.

14. The system for managing the aggregated purchase and fractionalized dispersal of energy products for vehicles of claim 13, wherein said administrator system additionally performs the step of determining the taxes which must be collected in connection with each of the generated reservation requests.

15. The system for managing the aggregated purchase and fractionalized dispersal of energy products for vehicles of claim 11, wherein the requirement signal from at least one of the plurality of vehicle modules includes data relating to at least one of a fuel level and an energy level of the corresponding vehicle.

16. The system for managing the aggregated purchase and fractionalized dispersal of energy products for vehicles of claim 15, wherein the requirement signal from at least one of the plurality of vehicle modules is transmitted automatically based on the at least one of the fuel level and the energy level falling below a predetermined threshold.

17. The system for managing the aggregated purchase and fractionalized dispersal of energy products for vehicles of claim 11, wherein the requirement signal from at least one of the plurality of vehicle modules is transmitted automatically based on a predetermined schedule.

18. The system for managing the aggregated purchase and fractionalized dispersal of energy products for vehicles of claim 11, wherein said at least one dispensing station module is additionally configured to transmit a replenishment signal to said administrator system related to any localized dispersal of said fulfillment energy product.

19. The system for managing the aggregated purchase and fractionalized dispersal of energy products for vehicles of claim 11, wherein said fulfillment energy product is less than or equal to the quantity of the desired energy product in the generated reservation request.

20. The system for managing the aggregated purchase and fractionalized dispersal of energy products for vehicles of claim 11, wherein said fulfillment energy product is equal to the quantity of the desired energy product in the generated reservation request.
